(19) United States
(12) Patent Application Publication
(10) Pub. No.: US 2015/0223008 A1
(43) Pub. Date: Aug. 6, 2015

(54) INTEGRATED MOBILE APPLICATION DEVELOPMENT PLATFORM

(71) Applicants: Mark A. Watson, Fleet (GB); Philip C. Weighill-Smith, Fleet (GB); Paul A. Duffin, Waterlooville (GB); Petr Vlk, Liberec (CZ); Szymon W. Kurcab, Mogilany (PL); Slawomir P. Malota, Kraków (PL); Jaroslaw K. Cora, Wieliczka (PL); Maciej K. Misiolek, Jaslo (PL); Pawel P. Duda, Kraków (PL); Michal J. Karpinski, Jaslo (PL); Joseph George, Boston, MA (US); Marcin W. Burda, Kraków (PL)

(72) Inventors: Mark A. Watson, Fleet (GB); Philip C. Weighill-Smith, Fleet (GB); Paul A. Duffin, Waterlooville (GB); Petr Vlk, Liberec (CZ); Szymon W. Kurcab, Mogilany (PL); Slawomir P. Malota, Kraków (PL); Jaroslaw K. Cora, Wieliczka (PL); Maciej K. Misiolek, Jaslo (PL); Pawel P. Duda, Kraków (PL); Michal J. Karpinski, Jaslo (PL); Joseph George, Boston, MA (US); Marcin W. Burda, Kraków (PL)

(21) Appl. No.: 14/685,135

(22) Filed: Apr. 13, 2015

Related U.S. Application Data
(63) Continuation of application No. 13/765,067, filed on Feb. 12, 2013.
(60) Provisional application No. 61/598,224, filed on Feb. 13, 2012.

(51) Int. Cl. H04W 4/00; H04W 4/26

(52) U.S. Cl. CPC H04W 4/003; H04W 4/001; H04W 4/26

(57) ABSTRACT

Provided herein is a method of and system for providing a software-as-a-service platform comprising implementing a mobile client application build phase to enable a developer-user to build a mobile client application; implementing, with a server computer, a mobile client application run phase to enable an end-user of the mobile client application to download and execute the mobile client application on a mobile device; and implementing a mobile client application manage phase to enable a manager-user to manage and analyze the usage of the mobile client application by the end-user.

### CROSS-REFERENCE TO RELATED APPLICATION

This application is a continuation of U.S. patent application Ser. No. 13/765,067, filed on Feb. 12, 2013, and claims the benefit and filing priority of U.S. provisional patent application Ser. No. 61/598,224, filed on Feb. 13, 2012.

### TECHNICAL FIELD

This invention relates to an integrated software-as-a-service platform that enables users to build, run and manage mobile applications. The platform can be deployed as a cloud-based solution or on a customer premise.

### BACKGROUND OF THE INVENTION

In order to become a mobile enterprise that creates, disseminates, implements and manages mobile applications, many different vendors and solutions are required. In many cases, highly skilled workers are required to interoperate with complex platforms and multiple contracts are required in a heterogeneous ecosystem. This implementation necessitates the involvement of carriers, device vendors, third party developers, management companies, analytics companies, third party application designers, and the like in order to provide the desired complete mobile solution.

The present invention integrated end-to-end platform that solves the existing problems of the prior art by providing three main phases of mobile solution development in a highly integrated and iterative manner.

### SUMMARY OF THE INVENTION

Provided herein is a method of and system for providing a software-as-a-service platform comprising implementing a mobile client application build phase to enable a developer-user to build a mobile client application; implementing, with a server computer, a mobile client application run phase to enable an end-user of the mobile client application to download and execute the mobile client application on a mobile device; and implementing a mobile client application manage phase to enable a manager-user to manage and analyze the usage of the mobile client application by the end-user.

Implementing a mobile client application build phase to enable a developer-user to build a mobile client application may include providing a set of APIs to the developer-user to integrate with a third-party software development program used by the developer-user to develop the mobile client application such that the mobile client application will be enabled to connect with the server computer during the mobile client application run phase, as well as providing a software development platform that enables the developer-user to build the mobile client application using a set of software development tools provided within the software development platform. The mobile client application may be a native application, a hybrid application, a managed hybrid application, a mixed mode application, or a web application.

Implementing a mobile client application manage phase to enable a manager-user to manage and analyze the usage of the mobile client application by the end-user may include providing the manager-user with a web page adapted to allow a plurality of management functions comprising remote wipe, assigning user roles, assigning applications to a plurality of user, viewing the installed applications of a user, and providing an application storefront for end-users to download and install mobile applications hosted by the server computer.

### BRIEF DESCRIPTION OF THE DRAWINGS

FIG. 1 is a flowchart showing the three main phases of build, run and manage, along with the various features and functions performed by each phase.

FIG. 2 illustrates the main functions carried out by each of the build, run, and manage phases of the process of the present invention.

FIG. 3 is an illustration of the software modules utilized in the preferred embodiment of the present invention.

FIG. 4 illustrates a decision chart of a matrix of decisions and data points that are taken into consideration when undertaking the build phase.

FIG. 5 illustrates various aspects of the mobile app types of the present invention.

FIG. 6 illustrates a decision chart of a matrix of decisions and data points that are taken into consideration when undertaking the run phase.

FIG. 7 illustrates the various functions of the AMP Client and AMP Server.

FIG. 8 illustrates a decision chart of a matrix of decisions and data points that are taken into consideration when undertaking the manage phase.

FIG. 9 illustrates a screen shot of a device details page that provides the manager with details about a particular user device such as a mobile phone

FIG. 10 is a screen shot of an application build and publishing page that is seen by the developer who is logged into AMP Manager and obtains the privileges to use the publishing capabilities shown in this Figure.

FIG. 11 is a screen shot from an iPhone of the Storefront that enables users to obtain apps as desired.

FIG. 12 is a screen shot of an enroll device iPhone page.

FIG. 13 is a user details screen provided by AMP Manager.

FIG. 14 is a user roles screen provided by AMP Manager, which displays the role(s) in the system to which the user has been assigned, such as user, app developer, user manager and the like.

FIG. 15 is a display of the devices that have been assigned to a particular user.

FIG. 16 is a screen shot of an application storefront that provides details about an app that a user may be considering for installation, including various sample screenshots and other details about the app.

FIG. 17 is a screen shot of a devices list page that provides information on the devices owned by a user, grouped by BYOD (bring your own device) personally owned devices as well as company owned devices.

FIG. 18 is a display showing applications that have been assigned to users in the system.

FIG. 19 is a device view of the storefront that a user would see on a mobile device, with similar functionality to FIG. 16.

### DETAILED DESCRIPTION OF THE PREFERRED EMBODIMENT

The preferred embodiment of the present invention provides a highly integrated platform for designing, building, integrating, publishing, running, managing, and analyzing mobile applications, known as “apps”, without needing to rely on external software tools or platforms. All of these technologies are joined together in a cohesive fashion, in which users can implement the entire platform or only certain parts of it. For example, rather than use the integrated app design and build phases described below, users may opt to use their own app designers or tools that will then integrate with the remaining phases of the platform.

Although the integrated platform of the present invention allows users of all levels of experience—from novice to expert—to fully design, build, and deploy mobile apps, this platform also allows designers who have already designed and built a mobile app to publish that app and curate it in the mobile storefront phase of this platform. Thus, this platform establishes multiple entry points that enable users to enjoy its benefits in many different manners.

Apps that may be generated with the present invention range from simple ones to more complex ones. For example, apps may include business widgets for submitting expense vouchers, taking a survey, travel authorizations, purchase order approvals, etc. Thus, users can build business-to-enterprise and business-to-consumer apps with this unified platform, which integrates multiple technologies and is hosted by a cloud service provider or installed on the customer premise.

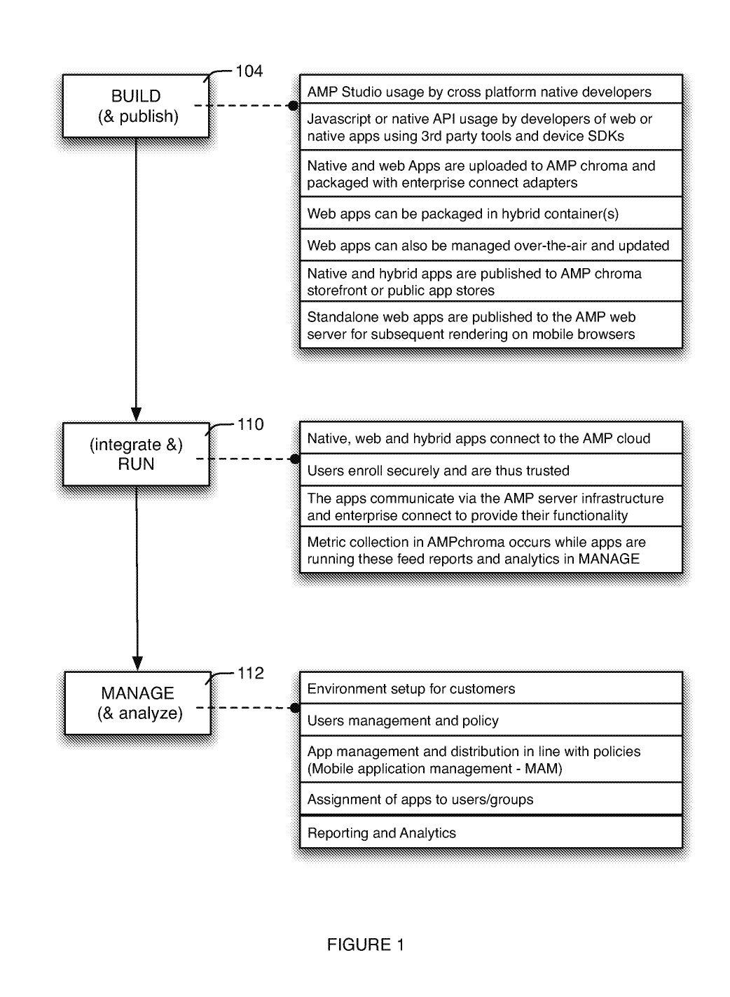

The platform of the preferred embodiment of the present invention implements three major phases as set forth in the flowchart of FIG. 1, which are the build phase 104, the run phase 110, and the manage phase 112, all of which comprise the mobile lifecycle and which are now described in detail. It is noted that in our prior provisional patent application Ser. No. 61/598,224 from which this application claims priority, the three major phases listed above were set forth in seven stages: design, build, integrate, publish, run, manage, and analyze. In this preferred embodiment we have eliminated the design phase, joined the publish phase with the build phase, combined the integrate phase with the run phase, and combined the analyze phase with the manage phase.

### The Main Preferred Embodiment

### The Three Integrated Phases of Build, Run and Manage

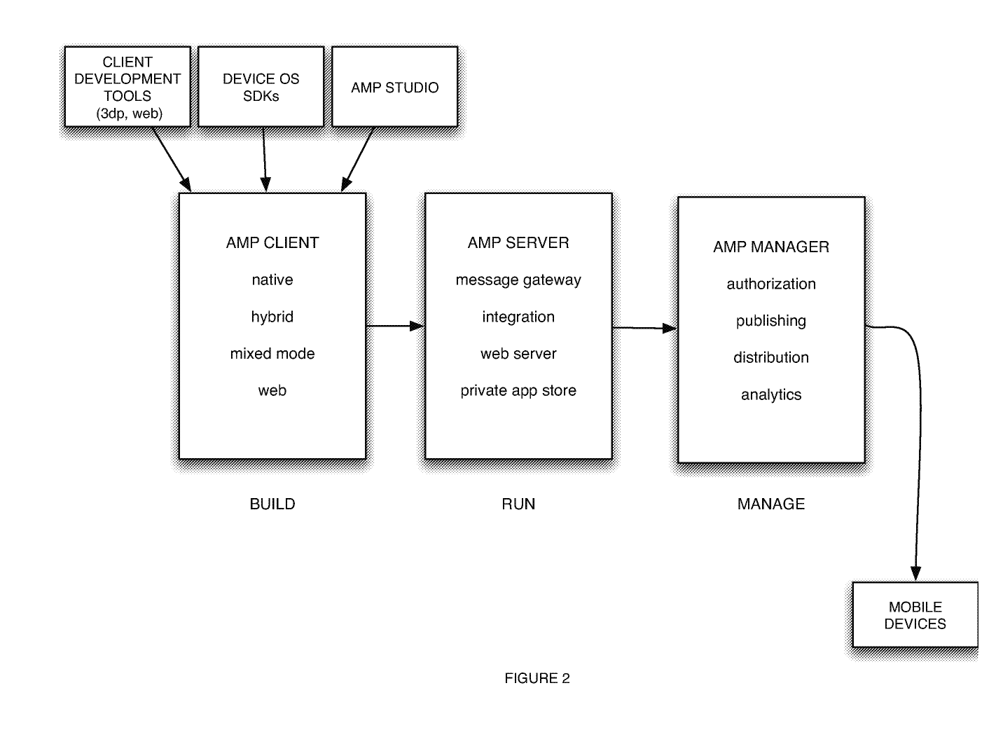

By streamlining the process into build, run and manage as will be described herein, users are benefited by being enabled to go to market faster, be able to have their own choice of client development thus providing greater flexibility, and help manage risks with respect to revisions to hardware and software (e.g. browsers) being made on a continuous basis. FIG. 1 shows the three main phases of Build 104, Run 110, and Manage 112, along with the various features and function performed by each phase. Reference is also made to FIG. 2, which illustrates the main functions carried out by each of the build, run, and manage phases of the process of the present invention. In the first main phase, the build phase 156, developers may implement off-the-shelf web application development toolkits 150 from any of various commercial vendors, such as JQUERY, DOJO, KENDO and SENCHA. In the event that the developer decides to use such a standard web app tool 150, then a Javascript API is provided that will enable the mobile app they develop to connect to the AMP Server in the run phase 158 to enable the mobile app to send and receive messages with the AMP Server and the back end system with which the mobile app will execute. Additional APIs are available to application developers to support user authentication, receive push notifications, capture mobile device location, obtain and update content from the server and submit application metrics to the server among other useful mobile application functions known in the art.

If applicable, the developer may instead utilize a standard IOS (Objective C/X Code) or ANDROID (Java) mobile app development tool 152. For example, if a user desires to build an IOS app, an Objective C library is provided for integration with the IOS app.

Or, if desired, the customer may implement a custom/native development tool referred to as AMP Studio 154, which is further described below. (AMP Studio 154 is also referred to as AMP Architect in the description below, which is an Eclipse plug-in module. That is, AMP Architect has been renamed to AMP Studio).

By utilizing any or all of these development tools 150, 152, 154, the developer is able to build the desired mobile app, which as shown in the build phase 156 in FIG. 2 is referred to as an AMP Client. An AMP Client may be a native client, a hybrid client, a mixed mode client, or a web client.

During the run phase 158, the AMP Server will run the mobile app that has been developed. The AMP Server is the switching point for the transactions between the mobile device running the mobile application developed under this process with the customer's back end servers.

During the manage phase 160, the AMP Manager as shown in FIG. 2 enables authorization of the user and device as they attempt to access the system, the app publishing and distribution process, as well as app usage and other analytics.

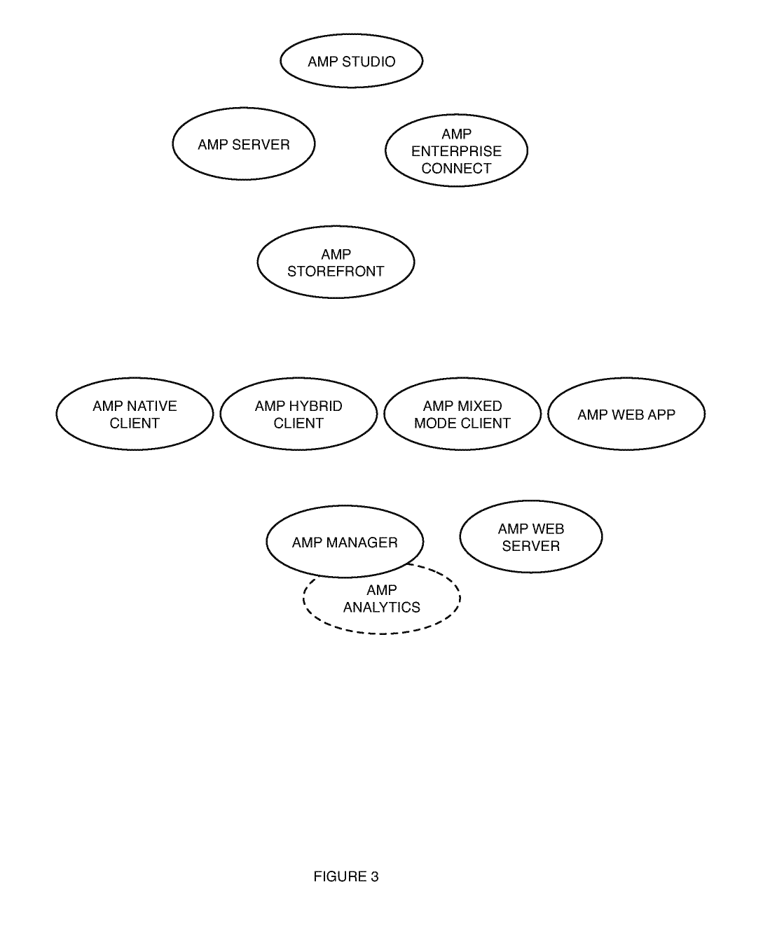

FIG. 3 is an illustration of the software modules utilized in the preferred embodiment of the present invention. The term “AMP” is a trademark of the applicant of the present invention and is used with the preferred embodiment in conjunction with various software modules such as AMP Storefront and the like.

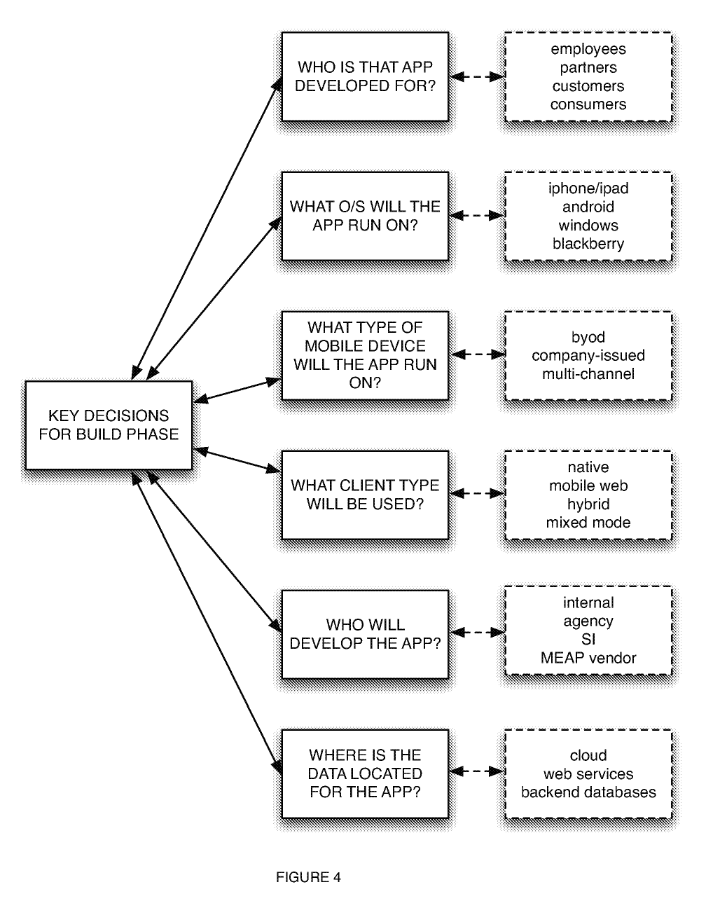

The decision chart in FIG. 4 illustrates a matrix of decisions and data points that are taken into consideration when undertaking the build phase. Inquiries are made as to who the app is developed for (e.g. employees, partners, customers, consumers), what operating systems the app will run in (iPhone/iPad, Android, Windows, BlackBerry), what type of mobile device the app will run on (BYOD (bring your own device), company-issued, multi-channel), what client type will be used (native, mobile web, hybrid, mixed mode), who will develop the app (internal, agency, SI, MEAP vendor), and where the data for the app will be located (in the cloud, web services, backend databases).

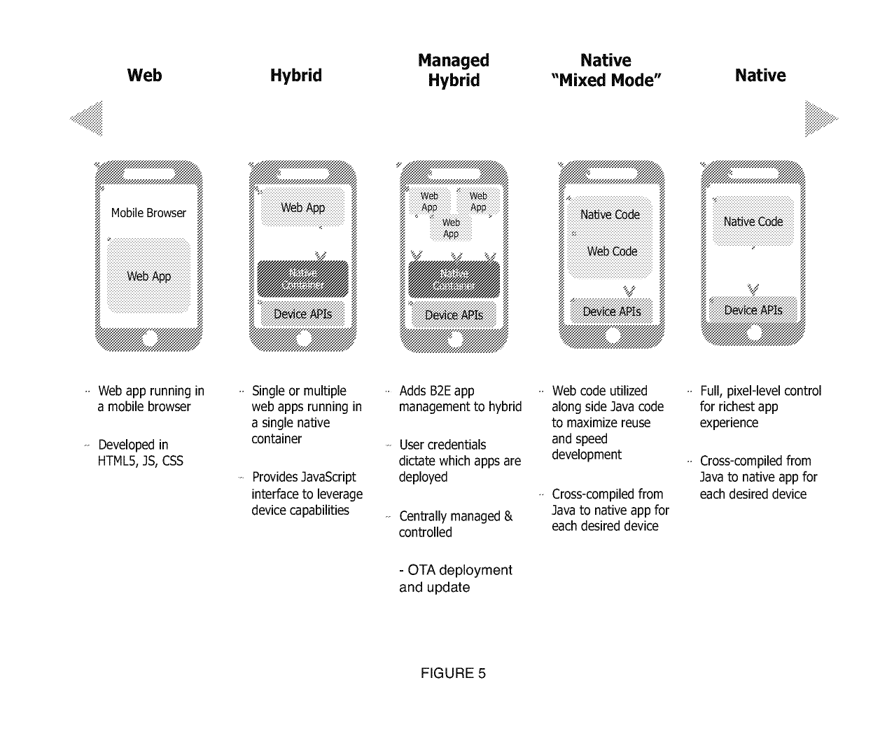

The mobile app types as described above will now be discussed in further detail with respect to FIG. 5. The first mobile app type is a web app which runs on a mobile browser such as Safari on an iPhone. This is typically developed in HTML5, Javascript, and CSS. These apps may be rendered differently, based on which device is connected (e.g. iPad vs. iPhone). A database is referenced that contains information about the particular device on which the app is running that will enable it to be rendered properly (e.g. based on display screen size).

The second mobile app type is a hybrid app which is a wholly contained single web app or multiple web apps running in a single native container which uses device APIs for accessing various resources of the mobile device such as files, the camera, etc. The third mobile app type is a managed hybrid app, which is similar to the hybrid app but differs in that it can be managed and updated over the air.

The fourth mobile app type is a native mixed mode app, in which web code is utilized alongside Java code to maximize reuse and speed development, and the web code can refer to a native library providing functions not typically available in device web browsers available at present.

The fifth mobile app type is a native app which may be built for example with the AMP Studio module, not using a web app as in the previous cases. This provides full, pixel-level control for the richest possible user experience, and is cross-complied from Java to the native code syntax for each desired device.

One major difference in this new embodiment, in which there are three phases (build, run and manage) with respect to the seven-phase embodiment described in our prior provisional application (and set forth below), is that the customer is provided with a series of APIs to enable them to use commercially available development tools and easily interface with the device and the system. On a higher level, each of these types of client apps will be different from each other as explained above. However, since they will each use APIs to provide interfaces to the system, all of the client types will share the same OS interface, the same secure access to the device database, and the same secure gateway interface.

### The Run Phase

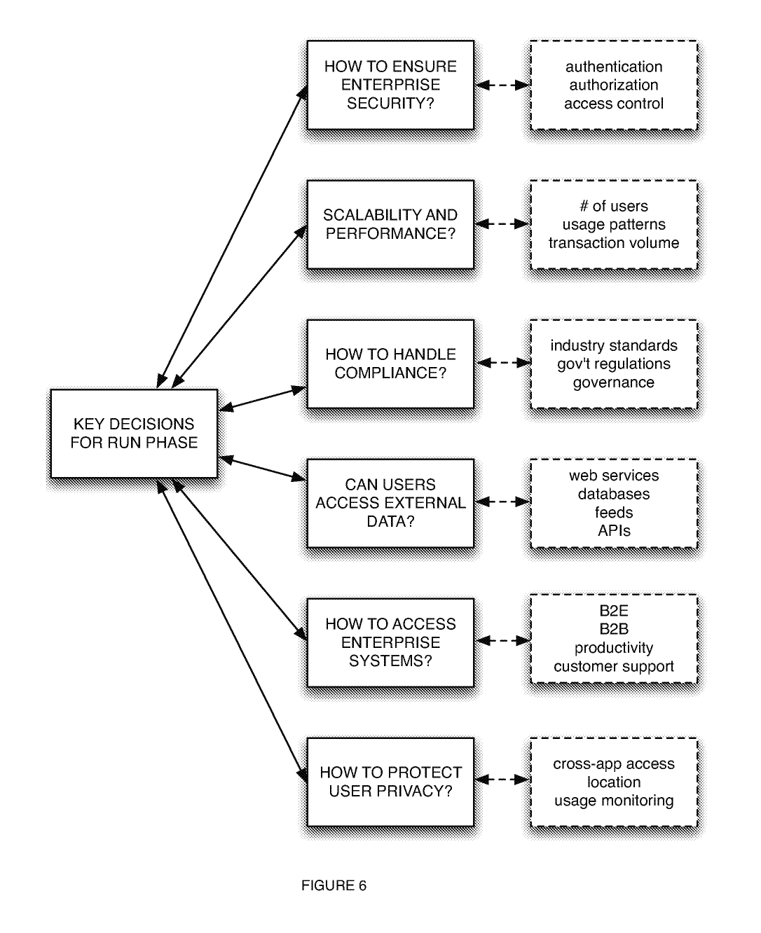

The decision chart in FIG. 6 illustrates a matrix of decisions and data points that are taken into consideration when undertaking the run phase. Inquiries are made as to how to ensure enterprise security (authentication, authorization, access control), scalability and performance (number of users, usage patterns, transaction volume), how to handle compliance (industry standards, government regulations, governance), can users access external data (web services, databases, feeds, APIs), how to access enterprise systems (B2E, B2B, productivity, customer support), and how to protect user privacy (cross-app access, location, usage monitoring).

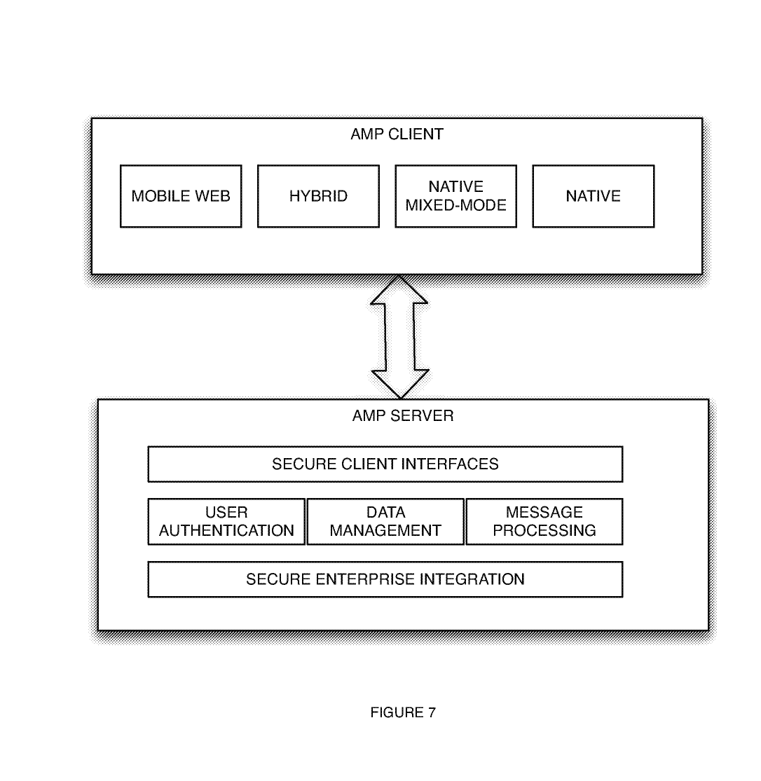

With reference to FIG. 7, during the Run phase, the client device will connect with the AMP server over a secure interface. The server has data management capabilities which process messages from the clients, through the server, to the data source and back to the client, which occurs over the Enterprise Connect module. While the application is running, the system collects various metrics and data points in order to analyze the performance of the end-to-end mobile solution.

### The Manage Phase

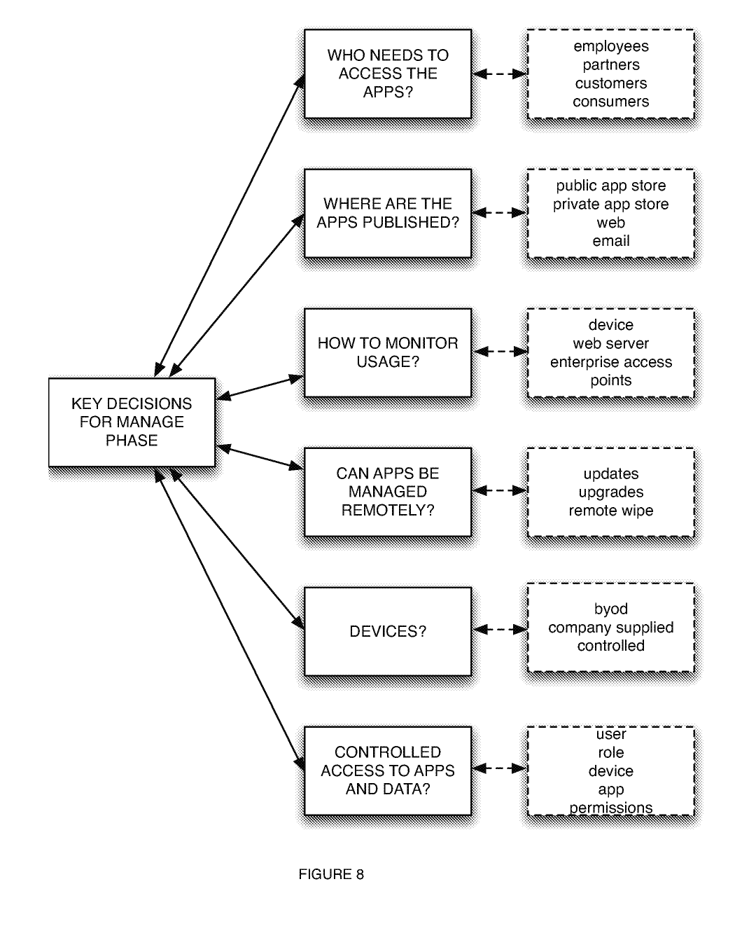

The decision chart in FIG. 8 illustrates a matrix of decisions and data points that are taken into consideration when undertaking the manage phase. Inquiries are made as to who needs access to the apps (employees, partners, customers, consumers), where the apps are published (public app store, private app store, web email), how to monitor usage (device, web server, enterprise access points), if apps can be managed remotely (updates, upgrades, remote wipe), the devices (BYOD (bring your own device), company supplied, controlled), and controlled access to apps and data (user, role, device, app, permissions).

The AMP Manager (a.k.a. AMP Device Manager) is a component that provides a centralized console to administer and monitor mobile deployments and set role-based administration. It provides performance and usage monitoring and app analytics.

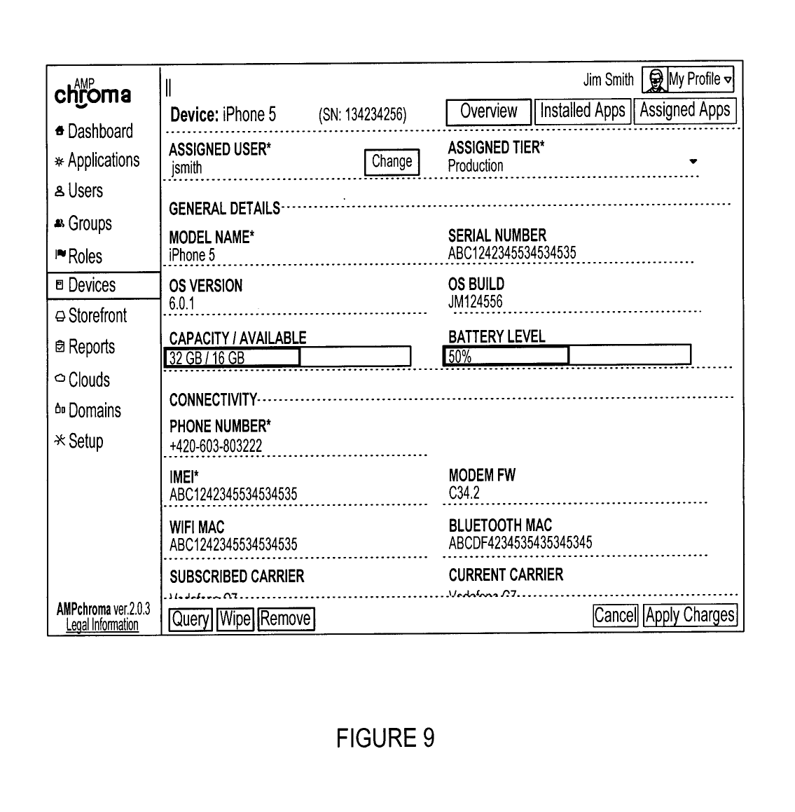

Under the AMP Manager, FIG. 9 illustrates a screen shot of a device details page that provides the manager with details about a particular user device such as a mobile phone. At the lower edge of the screen is a Wipe button that enables the mobile device to be remotely wiped if desired, as well as a Remove button that removes the device from the database. The Installed Apps button on the upper right part of the screen allows the viewer to see the apps that have been installed on the device, and the Assigned Apps button provides a list of the assigned apps set up for this device.

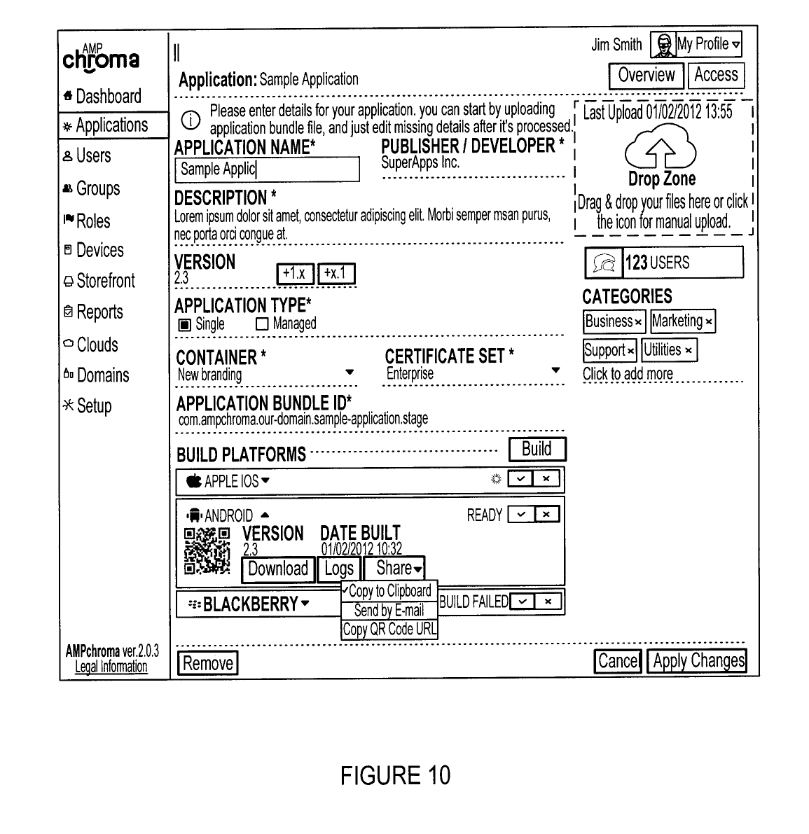

FIG. 10 is a screen shot of an application build and publishing page that is seen by the developer who is logged into AMP Manager and obtains the privileges to use the publishing capabilities shown in this Figure. The developer would drag the required files from his computer to the Drop Zone area on the right side of the screen, the files are then uploaded to the server, the target apps are built from the uploaded files based on the instructions provided on the rest of the page in FIG. 10. For example, if the developer would like to wrap a web app in a hybrid container, then this page allows the developer to provide the web app files to the server and the server then can build the desired app. A bar code symbol (QR code) is generated which encodes a link to a web resource (URL) that provides for downloading and installing that app by the user. The QR code and related web resource (URL) can be emailed or otherwise distributed to the intended users. If properly equipped, the user would simply scan the QR code by imaging it with the camera on the phone, and then the web resource would be linked to by the web browser as well known in the art.

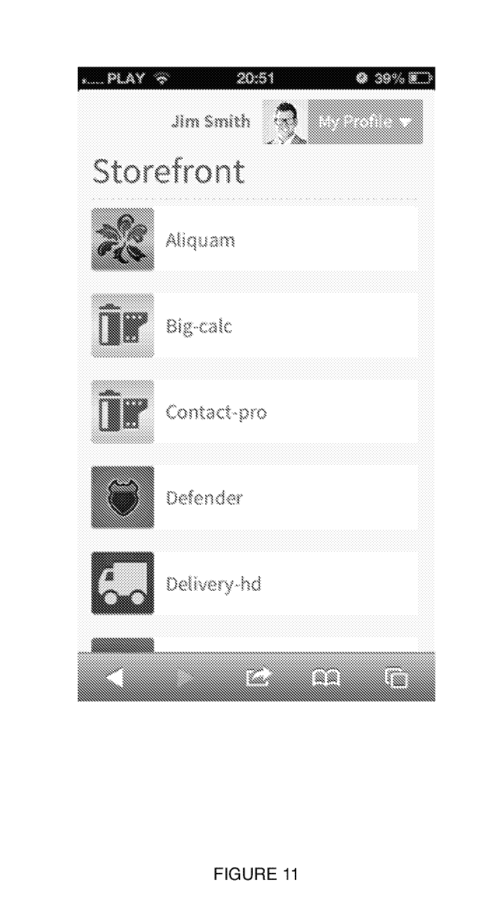

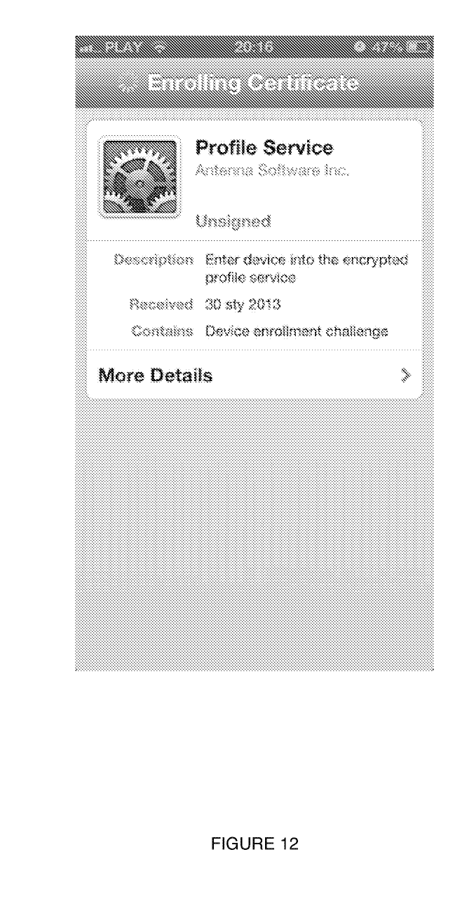

FIG. 11 is a screen shot from an iPhone of the Storefront that enables users to obtain apps as desired. Selection of any of the icons will provide a more detailed page that describes the app, as well as the ability to install the app if desired. FIG. 12 is a screen shot of an device registration page as it will appear on an iPhone. This enables the user to register his or her device with the system, which enables the system to ascertain the device being registered and provide apps etc. based on the device that has been registered and associated with the user at that time. Note that devices can also be shared by users and this is a further unique capability within this invention.

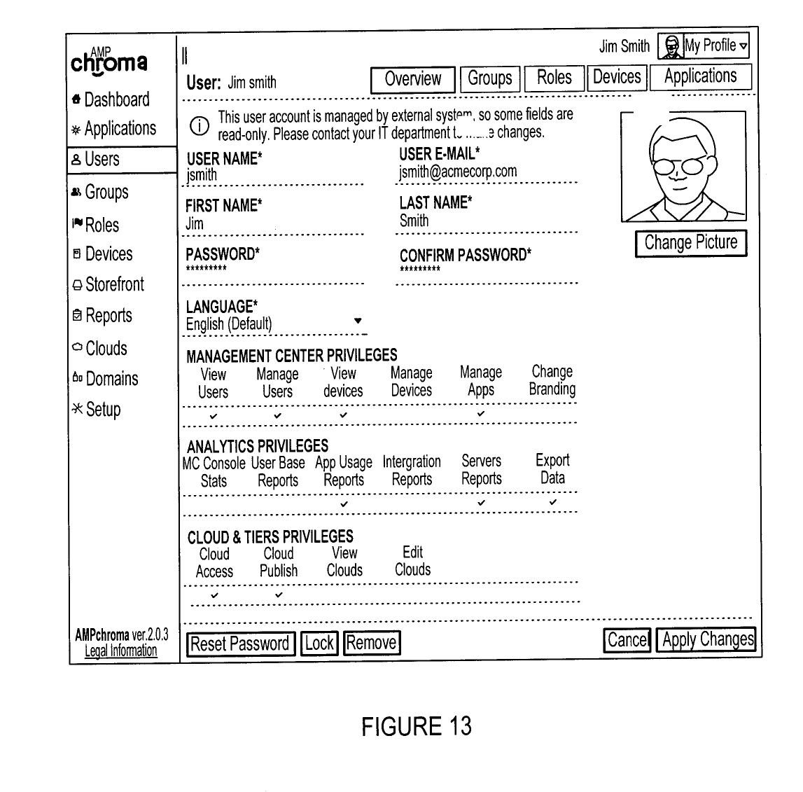

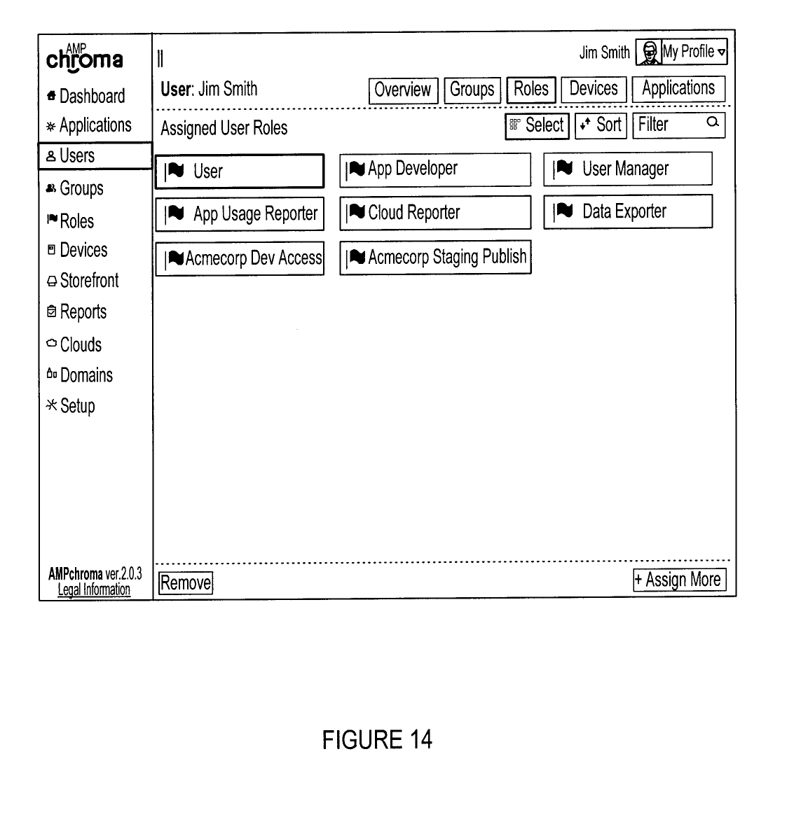

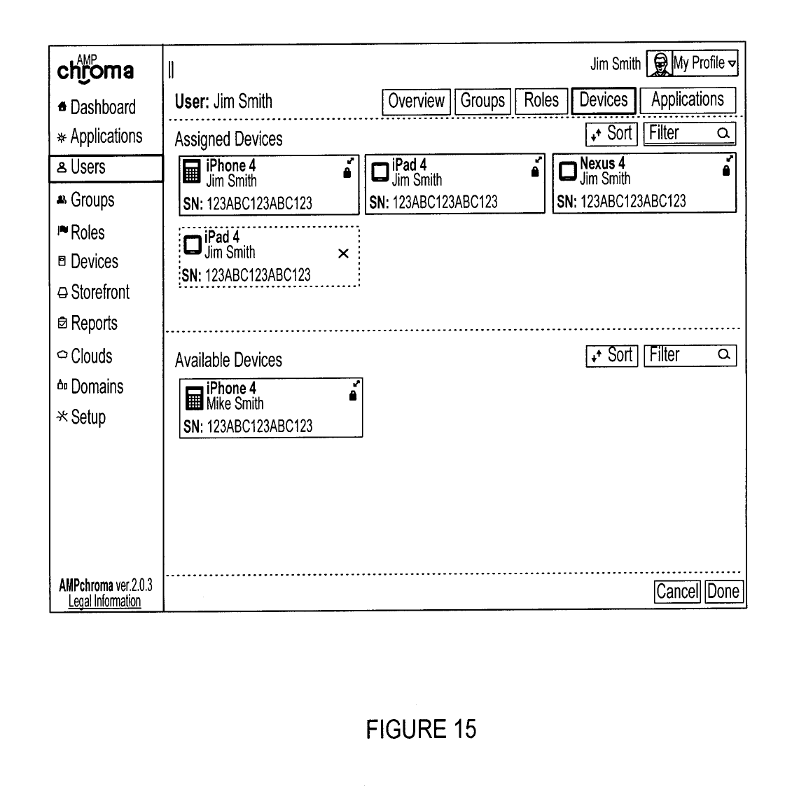

FIG. 13 is a user details screen provided by AMP Manager. Various details about the user are displayed, including the privileges that have been granted to that user (management center privileges, analytics privileges, and cloud and tiers privileges). FIG. 14 is a user roles screen provided by AMP Manager, which displays the role(s) in the system to which the user has been assigned, such as user, app developer, user manager and the like. FIG. 15 is a display of the devices that have been assigned to a particular user (e.g. iPhone, iPad, Nexus-4, etc.).

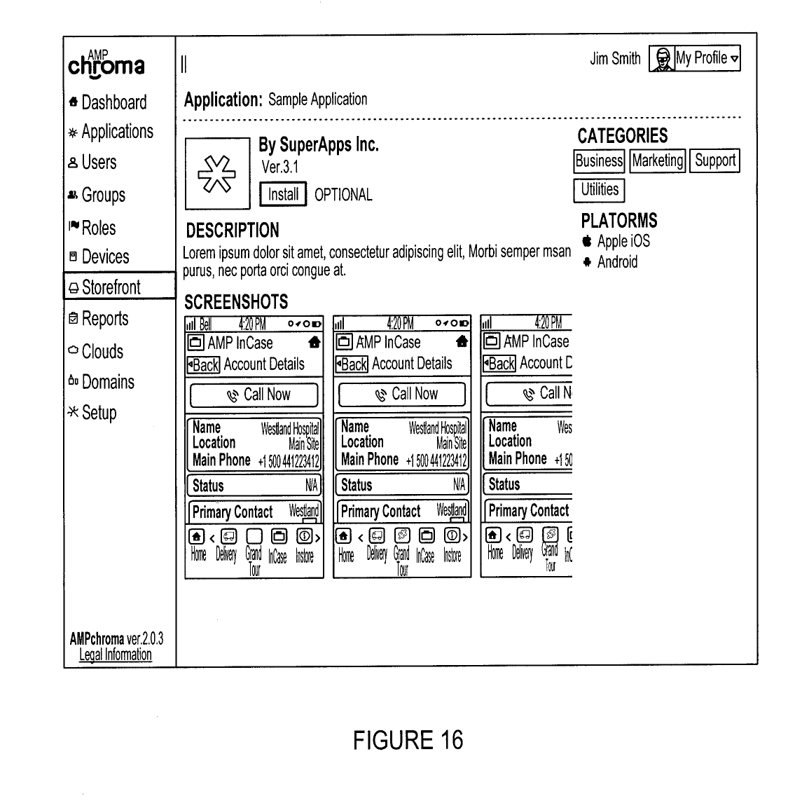

FIG. 16 is a screen shot of an application storefront that provides details about an app that a user may be considering for installation, including various sample screenshots and other details about the app.

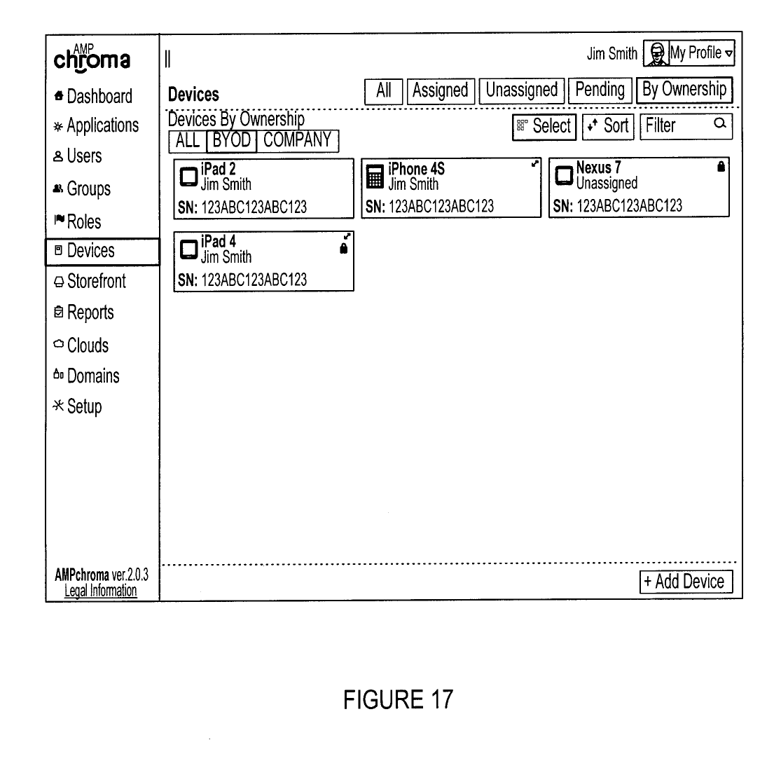

FIG. 17 is a screen shot of a devices list page that provides information on the devices owned by a user, grouped by BYOD (bring your own device) personally owned devices as well as company owned devices.

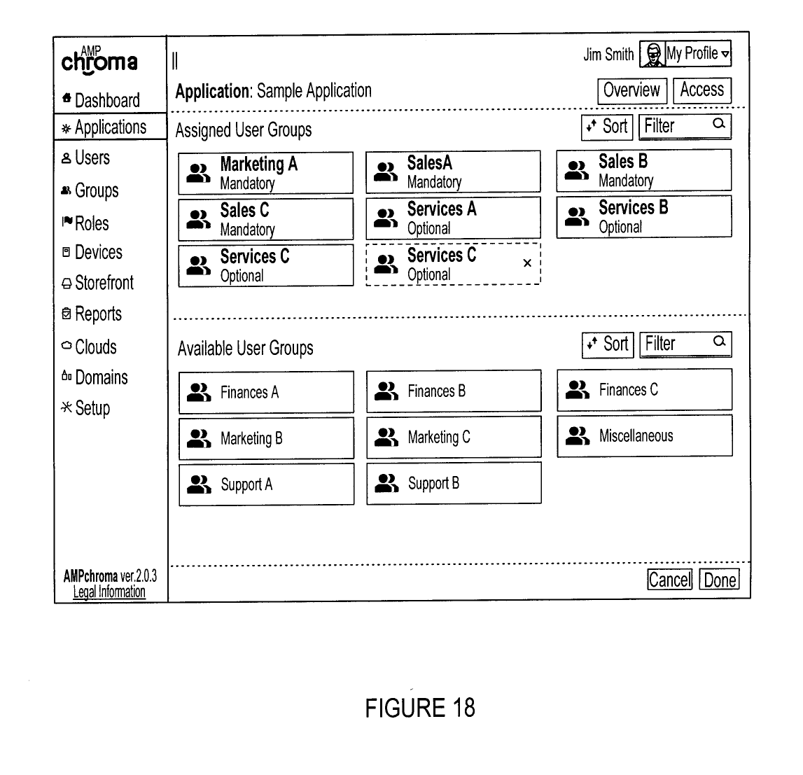

FIG. 18 is a display showing applications that have been assigned to users in the system. Here is where the operator can assign apps to various user groups, and since users may be in multiple groups they can be assigned applications for each membership group.

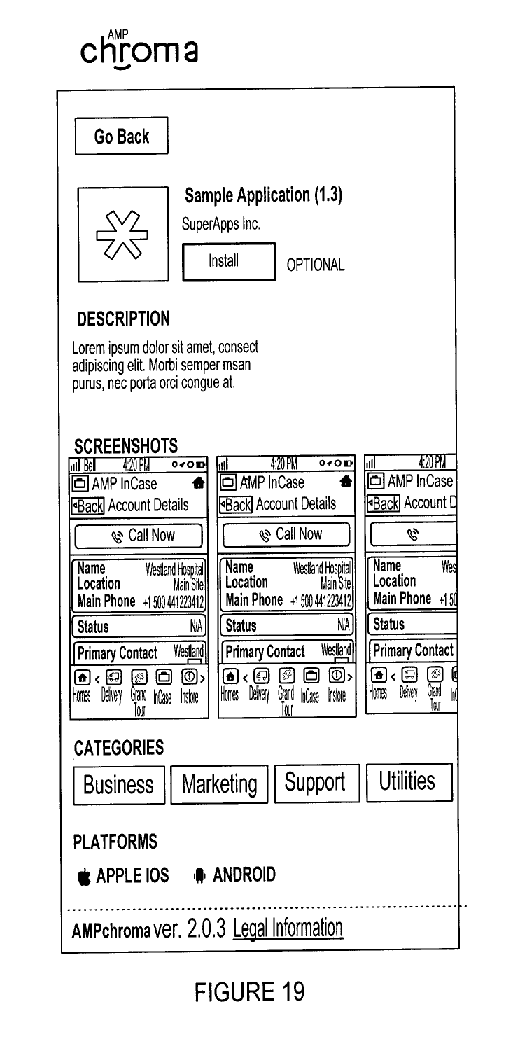

FIG. 19 is a device view of the storefront that a user would see on a mobile device, with similar functionality to FIG. 16.

### The Secondary Prior Seven-Phase Embodiment

The following describes the embodiment first disclosed in our prior provisional application, which implemented an earlier version in which seven phases were undertaken (design, build, integrate, publish, run, manage and analyze). As described above, this process has been streamlined to that of three phases (build, run, manage). This description is provided for explanation of various features that overlap between the two embodiments.

### 1. Design

The design phase enables a user to design a mobile app or web site in the AMP Builder drag and drop IDE (integrated development environment). The user will connect to the cloud-based service through a standard web browser and can create themes and templates for apps by using various pre-built application templates provided by the system. The user can design the various pages that comprise the mobile app, and he/she can add native and web user-interface controls to the apps as desired.

AMP Builder—

This software module provides a web based user interface with drag and drop configuration, thus requiring no specific programming skills. The AMP Builder output can be exported to AMP Studio, AMP Web and the AMP Hybrid Client, or published directly to AMP Web, AMP Hybrid Client, and an integrated or commercial app storefront. AMP Builder's intuitive and simple web interface guides the novice user through a straightforward process to design the page layout, themes and elements of an app or website. Users can choose from a rich set of pre-defined, branded app and site templates. By dragging and dropping widgets to form pages, the user graphically builds the navigation and can instantly preview the project across a variety of device formats.

A non-technical user can quickly create and publish a mobile app and site with a compelling and robust user interface that is automatically optimized across numerous device types such as smartphones, tablets and feature phones. AMP Builder is a WYSIWYG tool for creating native apps, mobile websites and HTML5 apps that run in a secure container. AMP Builder runs on top of AMP Web Server, enabling a rich mobile user experience across more than 10,000 devices and over 1,000 attributes per device. The AMP Builder user interface templates can easily be branded or rebranded to match corporate branding and styling. AMP Builder offers a powerful and intuitive drag-and-drop interface with a palette of extensible page widgets, including RSS feed integration and form development. AMP Builder administrators can review all published sites and apps, allowing easy review and approval, and enable role-based editor access.

In the AMP Builder Dashboard, a user may choose to create a new application, import an application, or edit an application from the list provided. When the user selects the Create App button, a set of templates is displayed. The user may select a template and begin creating the application (or, the user may create his own template, if desired). After a template is selected and a name for the app is entered, then the user may select a theme from a set of themes as provided. Selection of the template and theme will provide the desired look and feel and structure of the application being created.

FIG. 6 illustrates a screenshot of the AMP Builder editor web page. The first column on the left side shows several screens that are populated by the template and theme selection and will make up the application. In this case, a survey template has been selected, and several screens that are appropriate to taking a survey have been generated and are available for customization with the editor. The second column provides controls and capabilities that may be added to the application, such as text, images, XML, RSS feeds, logos, etc. The third column shows the layout of the screen, which in this example provides a logo, a text field, another text field, and a menu field. The fourth column (on the far right side) is a design preview that shows what the application pages will look like based on what the user has designed. A drop down list is provided for various types of target device previews (e.g. IPHONE, ANDROID, etc.) so the designer will be able to see exactly how the app will look on any given device.

For example, a designer is able to insert an image by dragging the Image icon from the second column into the desired location on the third column, and a pop up window will appear that enables the designer to select an image (e.g. from his computer drive) and place that image on the screen. The order of the sections in the third column may be changed by simple dragging operations, and the resulting screen image will be shown in the preview column. In addition, these sections may be deleted and/or edited if desired.

At some point, the designer can hand-off the basic design work to a more sophisticated programmer by exporting the application out of AMP Builder and importing it into the AMP Studio software module. AMP Studio enables a more sophisticated and intricate design process that facilitates going beyond the drag and drop interface of AMP Builder.

### 2. Build

The build phase 104 may be accomplished using the AMP Builder (described above), AMP Studio or AMP Architect platforms. A simple design may be ported from AMP Builder and exported to AMP Studio for further design work if desired.

AMP Studio—

This software module is a fully featured mobile web and HTML5 development toolkit that has an ECLIPSE-based development user interface for creating feature-rich apps that run via native, hybrid or web across any device. Employing an XHTML markup language, it eliminates the need for developers to understand the differences between all the device protocols and browser versions, so that development is made easier and faster.

AMP Studio uses familiar ECLIPSE-based IDE with XHTML markup to build any apps for any channel—native, hybrid or web.

AMP Studio provides an abstraction that enables developers to use a single code base to support all Internet protocols across different browsers and devices. It lowers the bar for mobile development by abstracting mobile browser variations to enable “create once, run anywhere” capability for rich user interfaces. AMP Studio Provides rich functionality for the latest smartphones while addressing all the nuances and potential software defects from one device manufacturer to another. AMP Studio enables easy and rapid integration with existing web services, content management systems, third party data sources and other backend systems.

For example, a Theme Design Wizard enables the designer to specify with more detail the parameters of the theme used in the app. The device database holds attributes of thousands of devices for which the app may be configured. Policies for any given device may be reviewed and changed if desired.

AMP Architect—

This software module is a development tool for a 100% native application, using an ECLIPSE-based development user interface. This generates native apps that can be installed on various devices without the need to adjust the code for each device. One single code base can be compiled into Android Java, Blackberry Java, iPhone Objective-C, and Windows Mobile .NET code, thereby reducing time, effort and costs. AMP Architect also includes ECLIPSE-based backend integration tools for Web Services and database access. It not only allows the programmer to create a rich user interface, but also to define business logic, access the local data store, and communication with backend Web Services or other data sources.

### 3. Integrate

In the integrate phase, a secure connection is made with backend systems or web data via the AMP Enterprise Connect.

AMP Business Gateway—

This is a highly scalable messaging interface for business and consumer data, using data compression with highly reliable data delivery techniques. AMP Business Gateway receives messages from the apps and connects to backend systems.

AMP Enterprise Connect—

This is a data gateway that allows secure and reliable interaction between the business gateway and enterprise data stored at the customer premises. AMP Enterprise Connect can integrate with multiple backend systems and data sources. A user can thereby design and build the apps using the tools provided by the platform herein (or using third party tools), and then connect the apps to APIs or message flows that connect through a business gateway to the enterprise data via the AMP Business Gateway and/or the AMP Enterprise Connect.

### 4. Publish

During the publish phase 108, mobile apps are published to a public (third party) app storefront or the AMP Storefront. There are two types of storefronts for publishing the apps:

AMP Enterprise Storefront—

This is an enterprise grade app store for the upload, management and delivery of apps within an enterprise. This provides a pre-configured, brandable on-device client and web client support. AMP Enterprise Storefront enables companies to allow employees and private partner communities with access to all corporate approved mobile apps and content. It powers native or web storefronts across any device and personalizes content based on employee profile and roles. Incorporating a BPEL-based workflow engine, AMP Enterprise Storefront allows for role-based administration to manage content curation and publishing processes. This allows creation of a private mobile app and content store accessible on more than 10,000 devices via mobile native or web storefronts. Full control over the storefront branding and the personalization of the end user experience based on preferences and roles is enabled. Digital content, such as business apps, videos, audio files, office documents, etc., may be uploaded and managed. External content may be integrated from third parties or through direct integration with existing websites and CMS systems. AMP Enterprise Storefront utilizes a sophisticated business workflow engine to coordinate content approvals and publishing via role-based administrator consoles.

AMP Consumer Storefront—

This is a consumer digital media store for the upload, management and delivery of apps and other digital content to consumers. This provides a pre-configured, brandable on-device client and web client support. A mobile app may be created and be made accessible to consumers on a multitude of devices via mobile native or web storefronts. Full control over the storefront is facilitated and branding and the personalization of the end user experience is based on preferences and subscription profiles. A user can upload and manage all digital content such as apps, videos, music, games, etc. External content may be integrated from third parties or through direct integration with existing websites and CMS systems.

A business workflow engine may be utilized to coordinate content approvals and publishing via role-based administrator consoles.

In the AMP Builder interface the designer has selected an option to publish the app to a Hybrid Client. By publishing the app, the system will package the app and put into onto the management servers. This will enable the designer to control deployment of the app to the desired users.

### 5. Run

During the run phase, mobile apps are run through scalable enterprise grade systems.

AMP Web Server—

This is a scalable and performant device-aware mobile web server, supporting thousands of transactions/second/CPU.

AMP Hybrid Client—

This is a native container allowing AMP Web Server authored apps to be deployed as native.

AMP Native Client—

This is a native client deployable to multiple platforms and supporting high end user interfaces.

### 6. Manage

The management phase enables control and management of the mobile ecosystem through a unified management console for app environment and provisioning. In the AMP Management Console, all AMP client architectures are supported, using a full BPEL (business process execution language)-based workflow system.

In this phase, permissions are defined for downloading of certain apps, wipe data, enable passcodes, install apps, retrieve a GPS location from a device, etc.

### AMP Device Manager

AMP Device Manager provides a central dashboard to monitor and administer mobile devices and the content stored and downloaded on them. Whether they are corporate issued or employee owned devices, IT can gain access to ensure that the end users are following proper security policies.

Additionally, AMP Device Manager offers a secure app container across a variety of devices that allows for central provisioning and deployment of pre-approved apps and content direct to users based on their roles and functions. In this manner, business mobility is sandboxed from personal mobility on the device for greater security. The AMP Device Manager enables users to maintain constant control over the entire mobile device ecosystem, remotely configure or lock devices and wipe business data, enforce device password policies, remotely configure WiFi and VPN settings, enable group-based policy management and roles-based admin control, deploy and manage approved apps and content via a container that separates enterprise data from personal data, and simplify the complex task of managing mobility with an intuitive web-based console.

For example the AMP Management Center showing an Application Manifest View. The sample app that was designed appears with the option “Include in Manifest” selected. When the user subsequently logs into the device, they will receive the update automatically that allows for the provisioning of that app.

### 7. Analyze

The analyze phase provides for the analysis of mobile effectiveness through an analytics paradigm.

### AMP Analytics

AMP Analytics operates as a clearinghouse for analytics collected by all AMP components (server side logs, device metrics collection). This is an online graphical web user interface launched from the AMP Management Center.

For example in the AMP Analytics functionality, numerous analytics reports may be accessed by the user as shown.

What is claimed is:

1. A method providing a software-as-a-service platform comprising:
a. implementing a mobile client application build phase to enable a developer-user to build a mobile client application;
b. implementing, with a server computer, a mobile client application run phase to enable an end-user of the mobile client application to download and execute the mobile client application on a mobile device; and
c. implementing a mobile client application manage phase to enable a manager-user to manage and analyze the usage of the mobile client application by the end-user.

2. The method of claim 1 wherein the step of implementing a mobile client application build phase to enable a developer-user to build a mobile client application comprises providing a set of APIs to the developer-user to integrate with a third-party software development program used by the developer-user to develop the mobile client application such that the mobile client application will be enabled to connect with the server computer during the mobile client application run phase.

3. The method of claim 1 wherein the step of implementing a mobile client application build phase to enable a developer-user to build a mobile client application comprises providing a software development platform that enables the developer-user to build the mobile client application using a set of software development tools provided within the software development platform.

4. The method of claim 1 wherein the mobile client application is a native application.

5. The method of claim 1 wherein the mobile client application is a hybrid application.

6. The method of claim 1 wherein the mobile client application is a managed hybrid application.

7. The method of claim 1 wherein the mobile client application is a mixed mode application.

8. The method of claim 1 wherein the mobile client application is a web application.

9. The method of claim 1 wherein the step of implementing a mobile client application manage phase to enable a manager-user to manage and analyze the usage of the mobile client application by the end-user comprises providing the manager-user with a web page adapted to allow a plurality of management functions comprising remote wipe, assigning user roles, assigning applications to a plurality of user, viewing the installed applications of a user, and providing an application storefront for end-users to download and install mobile applications hosted by the server computer.

10. A computer system for providing a software-as-a-service platform comprising as server computer programmed to:
a. implement a mobile client application build phase to enable a developer-user to build a mobile client application;
b. implement a mobile client application run phase to enable an end-user of the mobile client application to download and execute the mobile client application on a mobile device; and
c. implement a mobile client application manage phase to enable a manager-user to manage and analyze the usage of the mobile client application by the end-user.
